(19) United States
(12) Patent Application Publication
(10) Pub. No.: US 2007/0188645 A1
(43) Pub. Date: Aug. 16, 2007

(54) IMAGE OUTPUT APPARATUS, METHOD AND PROGRAM THEREOF, AND IMAGING APPARATUS

(75) Inventors: Shuuichi HORII, Kyoto (JP); Kenji ARAKAWA, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/674,331

(22) Filed: Feb. 13, 2007

(30) Foreign Application Priority Data
Feb. 15, 2006 (JP) 2006/037459

(51) Int. Cl. H04N 5/222

(52) U.S. Cl. 348/333.01

(57) ABSTRACT

An image output apparatus in which an image output synchronization signal generation circuit conventionally shared for both video (TV) use and liquid-crystal display (LCD) use is divided into two image output synchronization signal generation circuits. The two image output synchronization signal generation circuits are synchronized, and the image format can be changed without taking the current image format into consideration. Thereby, high-definition image formats and liquid-crystal display progressive scanning are supported. Also, a dedicated synchronization counter, which does not have a horizontal counter or a vertical counter, is provided separately from a vertical counter and horizontal counter of a TV image output synchronization signal generation circuit and a horizontal counter and vertical counter of an LCD image output synchronization signal generation circuit. The dedicated synchronization counter is used to manage the operation cycle of the overall system and to perform synchronization and phase adjustment of the TV image output and LCD image output by adjusting the timing for outputting a control signal to the vertical and horizontal counters of the TV image output synchronization signal generation circuit and LCD image output synchronization signal generation circuit.

### BACKGROUND OF THE INVENTION

(1) Field of the Invention

The present invention relates to an image output apparatus used in digital cameras (for example, digital still camera, digital video cameras, or the like) or display devices (for example, personal computers, video game devices, or the like) which can output plural image signals that correspond to differing image formats.

(2) Description of the Related Art

In recent years, devices which can simultaneously output plural image signals that correspond to differing image formats, such as digital cameras which include a liquid-crystal monitor and yet can also output captured image to TVs, video devices, or the like, have become widespread. An outline of a conventional type of such a device shall be given with reference to FIG. 1.

FIG. 1 is a function block diagram of a conventional digital still camera.

In the digital still camera shown in FIG. 1, an input image that has been inputted as an image input signal is processed by an image input circuit 26, an output image is processed by an image output circuit 58, and the processed output image is outputted, as an image output signal, to a TV 66 and a liquid-crystal display (LCD) 68, which are connected to but are external from a dedicated digital still camera LSI 64. The image input circuit 26 has an image input synchronization signal generation circuit 30, and the image output circuit 58 has an image output synchronization signal generation circuit 62.

The image input synchronization signal generation circuit 30 and image output synchronization signal generation circuit 62 each include a vertical counter and a horizontal counter, and generate a vertical synchronization signal and horizontal synchronization signal based on the count value of the counters. An image processing circuit 28 and a display processing circuit 60 operate in accordance with a timing determined through the vertical synchronization signal and the horizontal synchronization signal.

Here, when using a “monitor mode,” in which the input image is outputted as the output image as-is, it is necessary to synchronize the image input signal and the image output signal. Therefore, the image output synchronization signal generation circuit 62 is used as a master synchronization circuit, while the image input synchronization signal generation circuit 30 is used as a slave synchronization circuit; a control signal is outputted from the image output synchronization signal generation circuit 62 and the image input signal and image output signal are synchronized thereby.

In addition, with the conventional device, a TV image output that is outputted to a TV, video device, or the like, and an LCD image output that is outputted to an LCD, are both generated by the same image output synchronization signal generation circuit 62. This is because conventional image formats such as 525i National Television Standard Committee (NTSC), 625i Phase Alternation by Line (PAL), as shown in FIG. 2, have the same number of horizontal scanning lines and the same horizontal cycle, and thus the vertical counter and horizontal counter of the image output synchronization signal generation circuit 62 can be shared.

However, high-definition (HDTV) compliant devices have increased in recent years, and accordingly digital cameras that are high-definition compliant have come to be in demand. High-definition (HDTV) image formats include formats with various numbers of horizontal scanning lines, horizontal cycles, progressive/interlace scanning standards, and so on, such as 1920×1080 and 1280×720 (for example, see Patent Reference 1: Japanese Laid-Open Patent Application No. 2000-41225 (page 4)).

FIG. 2 is a chart showing details of various image formats. NTSC and PAL, which are examples of Standard Definition Television (SDTV), are shown in line (a) (525i; NTSC) and line (e) (625i; PAL) in FIG. 2. The 1920×1080 and 1280×720 high-definition (HDTV) formats shown in Patent Reference 1 respectively correspond to lines (c) (1125i) and (d) (750p) in FIG. 2. Here, in FIG. 2, “vertical counter number” indicates the total number of scanning lines in that image format, while “horizontal counter number” indicates a horizontal cycle count number when the clock operates at 27 MHz.

Accordingly, in order to output, from the image output circuit 58, images in the recent high-definition (HDTV) format in addition to the conventional SDTV NTSC/PAL formats, a image output synchronization signal generation circuit 62 that supports new vertical counter numbers and horizontal counter numbers is necessary.

Furthermore, LCDs which employ progressive scan NTSC/PAL image formats in addition to conventional interlace scan 525i (NTSC)/625i (PAL) image formats have recently appeared. Line (b) (525p) and line (f) (625p) in FIG. 2 correspond to these progressive NTSC/PAL formats.

In such a case as this, there is a problem in that, because the TV image output and LCD image output have different numbers of horizontal scanning lines and different horizontal cycles, the vertical counter and horizontal counter of the image output synchronization signal generation circuit 62 cannot be shared.

In order to solve this problem and provide support for high-definition (HDTV) and LCD progressive scan image formats, there is a method which simply divides the image output synchronization signal generation circuit 62, which is conventionally shared between TV and LCD uses, into two. However, problems concerning the operational cycle arise in the case where the image output synchronization signal generation circuit 62 is simply divided in two; these problems shall be explained hereafter.

When simply dividing the image output synchronization signal generation circuit 62, a system in which one of the synchronization signal generation units is used as a master (standard) synchronization circuit and outputs a control signal, and the slave synchronization circuit is synchronized with the master synchronization signal, is necessary.

Detailed explanations shall be provided using FIG. 3.

FIG. 3 (a) shows a timing chart for a TV image output synchronization signal generation circuit, while FIG. 3 (b) shows a timing chart for an LCD image output synchronization signal generation circuit. First, both image output synchronization signal generation circuit have operation cycles of 59.94 Hz when operating at the same 59.94 Hz, and thus synchronization is not necessary. Here, when, at change point 1, the TV image output synchronization signal generation circuit changes from 59.94 Hz to 60 Hz, the operation cycles of the TV image output synchronization signal generation circuit (60 Hz) and the LCD image output synchronization signal generation circuit (59.94 Hz) differ, and thus a mismatch, as indicated by “A,” occurs.

Next, at change point 2, the TV image output synchronization signal generation circuit changes from 60 Hz to 50 Hz, and the LCD image output synchronization signal generation circuit changes from 59.94 Hz to 50 Hz. In this case, the TV image output synchronization signal generation circuit is the master, and the LCD image output synchronization signal generation circuit is the slave; a control signal is outputted from the TV image output synchronization signal generation circuit to the LCD image output synchronization signal generation circuit, thereby synchronizing the TV image output synchronization signal generation circuit and the LCD image output synchronization signal generation circuit and changing the operation cycle. Alternatively, situations in which the LCD image output synchronization signal generation circuit is the master and the TV image output synchronization signal generation circuit is the slave can also be considered.

Next, at change point 3, the TV image output synchronization signal generation circuit changes from 50 Hz to 60 Hz, and the LCD image output synchronization signal generation circuit changes from 50 Hz to 59.94 Hz. As the pre-change operation cycles are both 50 Hz, synchronization is not necessary even if the operation cycles of the TV image output synchronization signal generation circuit and LCD image output synchronization signal generation circuit change. However, when the TV image output synchronization signal generation circuit operates at 60 Hz, and the LCD image output synchronization signal generation circuit operates at 59.94 Hz, the operation cycles are different, and thus a mismatch as indicated by “B” arises.

Next, at change point 4, the TV image output synchronization signal generation circuit changes from 60 Hz to 59.94 Hz. In this case, the TV image output synchronization signal generation circuit is the master, and the LCD image output synchronization signal generation circuit is the slave; a control signal is outputted from the TV image output synchronization signal generation circuit to the LCD image output synchronization signal generation circuit, thereby synchronizing the TV image output synchronization signal generation circuit and the LCD image output synchronization signal generation circuit and changing the operation cycle. However, situations in which the LCD image output synchronization signal generation circuit is the master and the TV image output synchronization signal generation circuit is the slave can also be considered.

Note that change point 1 indicates a case such as where a 59.94 Hz SDTV NTSC format image is changed to a higher definition 60 Hz HDTV format on the TV side, whereas change point 2 indicates a high-definition 60 Hz HDTV image is changed to a 50 Hz SDTV PAL format image on the TV side.

Here, explanations shall be given regarding a combination of the operation cycle and image format of the TV image output and LCD image output that must correspond in order to support high-definition (HDTV) image formats, liquid-crystal display (LCD) progressive scanning, and the like. As shown in FIG. 4, only two operation cycles, or 59.94 Hz and 50 Hz, are found in conventional TV image output and LCD image output; as there is only one image format for each of these operation cycles, it is possible to share the vertical counter and horizontal counter of the image output synchronization signal generation circuit 62, and thus switching modes is a simple procedure. However, when the concepts of high-definition and progressive scanning come into play, the situation shown in FIG. 5 arises. In FIG. 5, the operation cycles are classified into HDTV or SDTV and arranged on the horizontal, while the vertical is classified into interlace and progressive scan LCD image output formats. Note here that in the smaller blocks nested within the chart, the upper level indicates video/TV image output, while the lower level indicates LCD image output.

In the situation shown in FIG. 5, it is necessary to use a dedicated TV image output synchronization signal generation circuit and a dedicated LCD image output synchronization signal generation circuit for video (TV) and liquid-crystal display (LCD) respectively; as can be seen in FIG. 5, not only are there are three operation cycles, or 59.94 Hz, 50 Hz, and 60 Hz, but there are also plural image formats for each operation cycle, and thus switching modes is complicated. For example, as with the TV image output in 114 and 118 shown in FIG. 5, while the operation cycle is the same 50 Hz, 114 is 625i (PAL) and 118 is 1125i, the counter numbers of the image format vertical counter and horizontal counter are different.

In other words, when simply dividing the image output synchronization signal generation circuit 62 into two, it is necessary to synchronize the TV image output and LCD image output image output synchronization signal generation circuits 62 to one another. However, there is a problem when simply dividing the image output synchronization signal generation circuit in two in that, in the case of changing the image format of the image output circuit 58, the operation cycle of the current image format, such as TV image output or LCD image output, must be found, and whether or not to change the operation cycle and image format using one of the divisions as the master (standard) must be taken into consideration, which leads to a complicated procedure.

Accordingly, an object of the present invention, which has been conceived in light of the abovementioned problem, is to provide an image output apparatus in which it is possible, even in a case where the image output synchronization signal generation circuit is divided into several separate circuits, to synchronize the separate circuits, and in which it is possible to change each operation cycle and image format without taking into consideration the image formats of the image output circuits.

### SUMMARY OF THE INVENTION

The image output apparatus according to the present invention outputs an image signal to plural display devices, and includes: plural image signal output units, each of which outputs an image signal corresponding to at least one image format; and a synchronization unit which synchronizes the plural image signals outputted from the plural image signal output units.

Furthermore, the synchronization unit of the image output apparatus according to the present invention includes a synchronization counter which can count to a maximum value set in accordance with the cycle of an image format, and the synchronization unit synchronizes the plural image signals based on the count value of the synchronization counter.

Furthermore, each of said plural image signal output units of the image output apparatus according to the present invention includes an image output synchronization signal generation unit having a vertical counter and a horizontal counter, both of which can count to the set maximum value, and the synchronization unit synchronizes the count value of the synchronization counter with the vertical counter and horizontal counter included in the plural image output synchronization signal generation units.

Furthermore, the synchronization unit of the image output apparatus according to the present invention adjusts the phase of the outputted image signal when the count value of the synchronization counter is a predetermined value so that the vertical counter and horizontal counter are reset.

Through this configuration, a synchronization unit such as a dedicated synchronization counter or the like that does not have a horizontal counter or a vertical counter is provided in the image output apparatus in addition to horizontal counters and vertical counters provided in the TV image output synchronization signal generation unit and LCD image output synchronization signal generation unit, which are in turn respectively provided in the TV image output unit and LCD image output unit that make up plural image signal output units. It therefore is possible to manage the operation cycle of the overall system as well as to adjust the cycle and phase of the TV image output and LCD image output by adjusting the timing at which a control signal is outputted to the vertical counter and horizontal counter of the TV image output synchronization signal generation unit and LCD image output synchronization signal generation unit included in plural image signal output units.

It should be noted that the present invention may be realized not only as such an image output apparatus but also as an image output method which implements the characteristic units of the image output apparatus as steps, and as a program which causes a computer to execute those steps. Moreover, it goes without saying that such a program may be distributed via a storage medium such as a CD-ROM or a transmission medium such as the Internet.

Through the image output apparatus according to the present invention, it is possible to easily synchronize the image output synchronization signal generation circuits of the TV image output and LCD image output, which are the plural image outputs, to one another by using a dedicated synchronization counter as a standard; it is also possible to change the operation cycles and image formats of the video (TV) image output circuit and liquid-crystal display (LCD) image output circuit without taking into consideration the current image format of those image output circuits.

Furthermore, when performing phase adjustment on the output starting position of the LCD image output signal and the TV image output signal, which are the plural image outputs, the dedicated synchronization counter, which is used as the standard, does not include the horizontal counter and vertical counter concepts, and therefore phase adjustment through absolute delay becomes possible.

### Further Information about Technical Background to this Application

The disclosure of Japanese Patent Application No. 2006-037459 filed on Feb. 15, 2006, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing an overall configuration of parts of a digital still camera according to conventional art.

FIG. 2 is a chart showing a list of vertical counter numbers and horizontal counter numbers for each image format.

FIG. 3 is chart showing an overall timing in the case where an image output synchronization signal generation circuit is simply divided in two.

FIG. 4 is a diagram showing an example of a combination of NTSC/PAL image formats for TV image output and LCD image output.

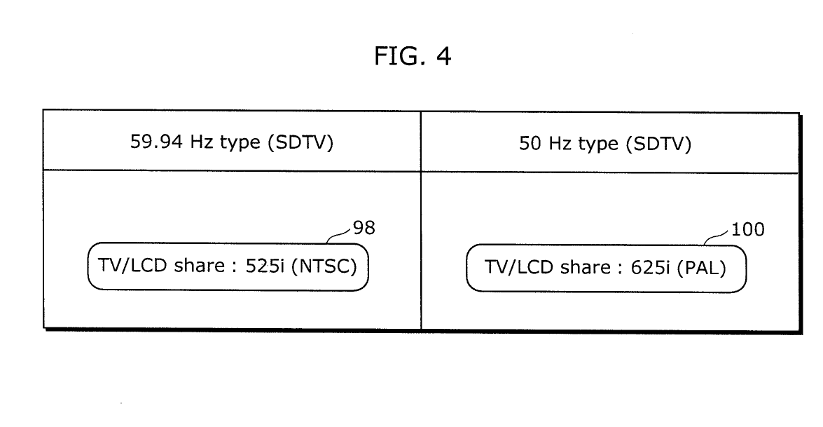

FIG. 5 is a diagram showing various combinations of image formats for TV image output and LCD image output.

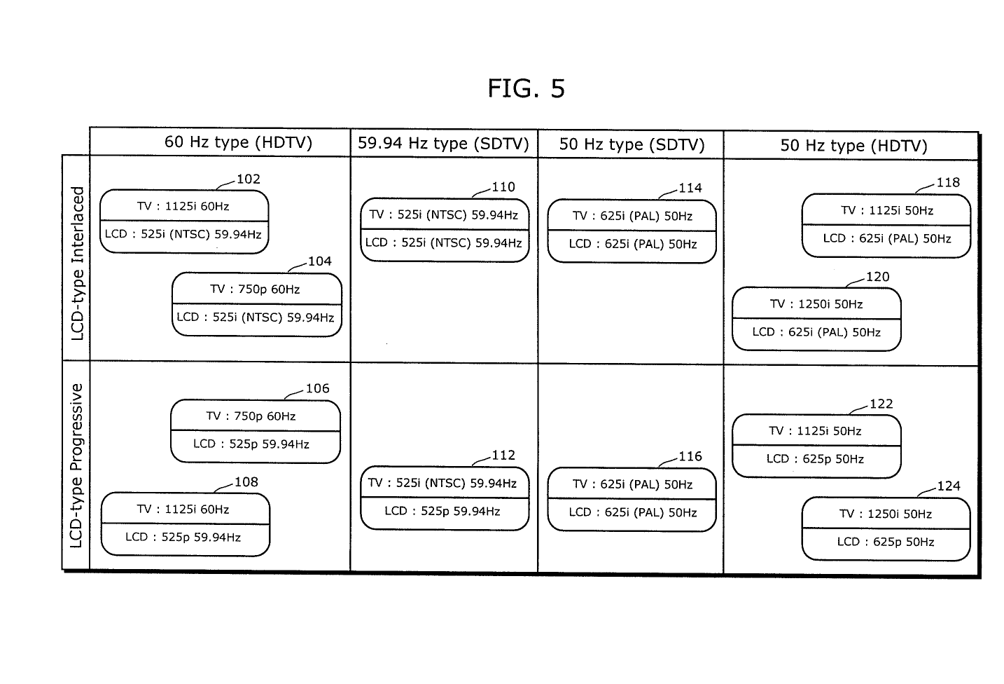

FIG. 6 is a block diagram showing an overall configuration of parts of a digital still camera according to the present invention.

FIG. 7 is a block diagram showing a configuration of a dedicated synchronization counter according to the present invention.

FIG. 8 is a flowchart showing an operation of a dedicated synchronization counter according to the present invention.

FIG. 9 is a chart showing a list of operation cycles and operation cycle counter values.

FIG. 10 is a block diagram showing a configuration of an image output synchronization signal generation circuit.

FIG. 11 is a flowchart showing an operation of an image output synchronization signal generation circuit.

FIG. 12 is a chart showing detailed timings during normal operation of the dedicated synchronization counter of the present invention.

FIG. 13 is a chart showing detailed timings during image format switching operation performed by the dedicated synchronization counter of the present invention.

FIG. 14 is a chart showing detailed timings during synchronization and phase adjustment performed by the dedicated synchronization counter of the present invention.

FIG. 15 is a chart showing an overall timing of the dedicated synchronization counter of the present invention.

FIG. 16 is a diagram showing an example where a digital still camera that includes the image output apparatus of the present invention is connected to a TV and the image output signal is changed.

### DESCRIPTION OF THE PREFERRED EMBODIMENT

Hereafter, an image output apparatus embodying the present invention shall be described with reference to the drawings.

### EMBODIMENT

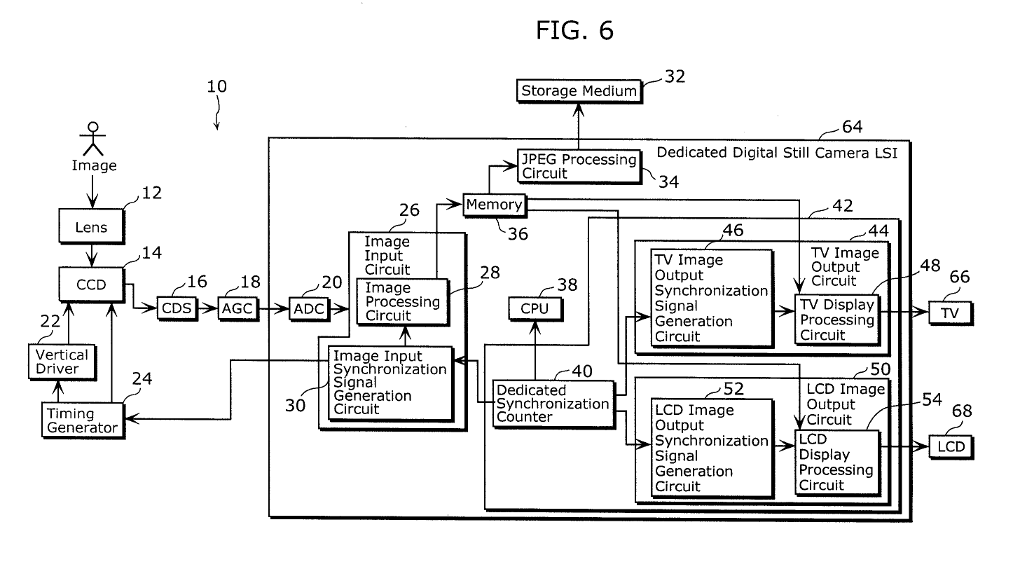

Embodiments of an image synchronization signal generation circuit and the image output apparatus according to the present invention shall be described in detail based on the drawings, with a digital still camera used as an example. FIG. 6 shows an overall configuration of parts of the digital still camera that are related to the present invention.

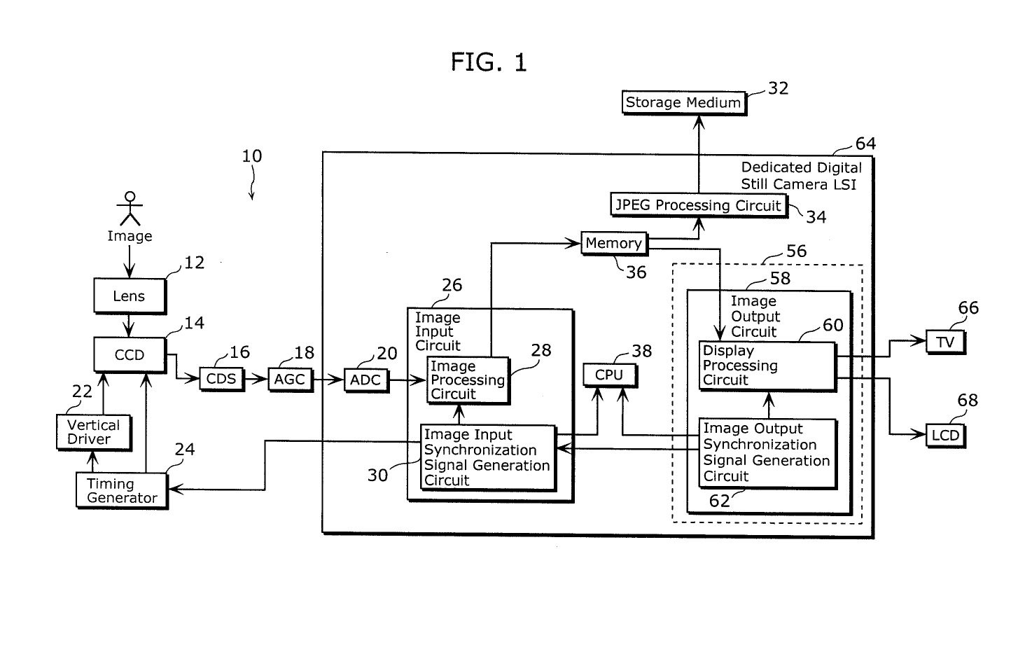

The essential difference between the FIG. 6 and the configuration example of the digital still camera given in FIG. 1 is that an image output circuit 42 is provided in place of the conventional image output circuit 56.

In other words, the image output synchronization signal generation circuit 62 shared between video (TV) and liquid-crystal display (LCD) in the conventional art has been divided into a TV image output synchronization signal generation circuit 46 and an LCD image output synchronization signal generation circuit 52 in the present invention in order to support the high-definition (HDTV) image format and the liquid-crystal display (LCD) progressive scanning. Furthermore, a dedicated synchronization counter 40 has been added to synchronize or perform phase adjustment on the TV image output synchronization signal generation circuit 46 and the LCD image output synchronization signal generation circuit 52. Here, “phase adjustment” refers to intentionally displacing the synchronization signal in order to displace the timing of the output signal.

In the digital still camera 10 shown in FIG. 6, an image is formed on a charge coupled device (CCD) 14 by the image of an object passing through a lens 12; the CCD 14 converts the light signals to electrical signals for each pixel and collects the electrical signals as charges. The CCD 14 is driven by a timing generator 24 and a vertical driver 22, and outputs the image signal collected as charges. The image signal acquired as analog image data from the CCD 14 is sampled through correlated double sampling (CDS), and the gain is adjusted through automatic gain control (AGC) so that the signal is of an appropriate level. The gain-adjusted image signal is inputted into a digital still camera LSI 64. The digital still camera LSI includes a CPU 38; the CPU 38 controls a Joint Photographic Experts Group (JPEG) processing circuit 34, an image input circuit 26, a TV image output circuit 44, and an LCD image output circuit 50.

The image signal, which is the analog image data and which has been inputted into the LSI, is converted into a digital signal by an analog/digital converter (ADC) 20. The post-conversion digital signal is inputted into the image processing circuit 28 as an image input signal. The image input signal is stored as digital image data in a memory (temporary storage device) 36 after undergoing YC processing and the like in the image processing circuit 28. The digital image data stored in the memory (temporary storage device) 36 is processed by a TV display processing circuit 48, and is outputted as an image to a TV 66, which is connected externally. In the same manner, the digital image data stored in the memory (temporary storage device) 36 is processed by an LCD display processing circuit 54, and is outputted as an image to a liquid-crystal display (LCD) 68, which is connected externally. In addition, the digital image data stored in the memory (temporary storage device) 36 is compressed by the JPEG processing circuit 34 and stored in a storage medium 32.

The image input synchronization signal generation circuit 30 generates, via the timing generator 24, an external image input synchronization signal that determines the timing at which the analog image data is taken from the CCD 14, and outputs that signal; the image input synchronization signal generation circuit 30 also generates an internal image input synchronization signal that determines the timing at which the image input signal is taken and outputs that signal to the image processing circuit 28. The TV image output synchronization signal generation circuit 46 generates and outputs, to the TV display processing circuit 48, an image output synchronization signal necessary for outputting images in NTSC/PAL image formats. In the same manner, the LCD image output synchronization signal generation circuit 52 generates and outputs, to the LCD display processing circuit 54, an image output synchronization signal necessary for outputting images in NTSC/PAL image formats.

A characteristic of the present invention is that the dedicated synchronization counter 40 is provided as a synchronization unit for synchronizing the image input synchronization signal generation circuit 30, the TV image output synchronization signal generation circuit 46, and the LCD image output synchronization signal generation circuit 52.

The dedicated synchronization counter 40 is a counter which is reset upon counting to a predetermined maximum value; the count value is outputted to the three synchronization signal generation circuits.

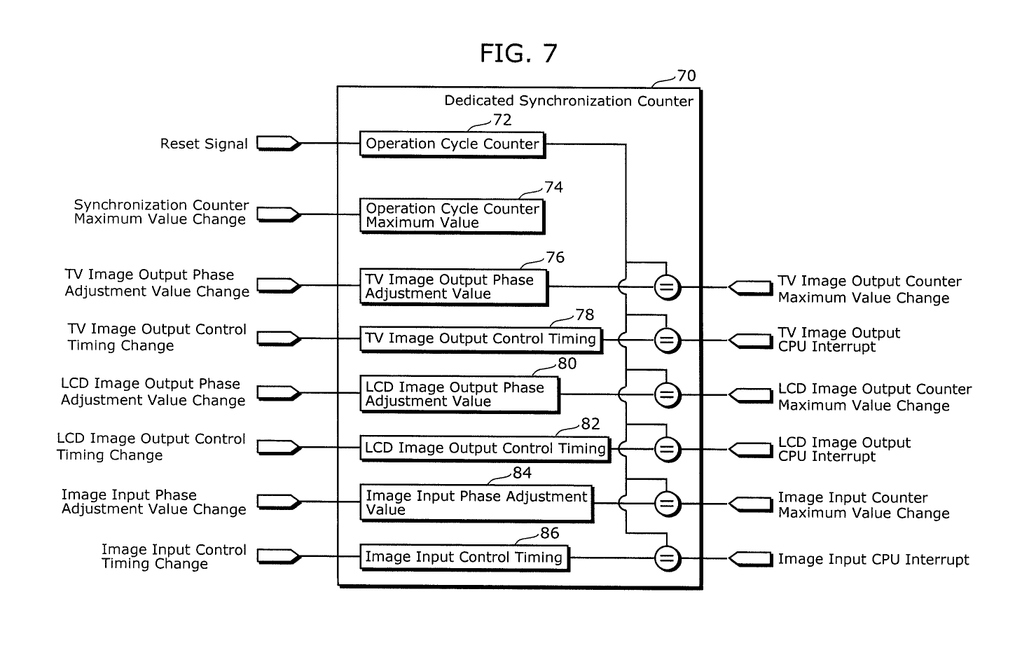

Operations of the dedicated synchronization counter 40 shall be described using FIGS. 7 to 9. FIG. 7 is a diagram showing a detailed configuration of the dedicated synchronization counter 40. As shown in FIG. 7, the dedicated synchronization counter 40 includes an operation cycle counter 72 which is synchronized with a clock and which performs counting, and an operation cycle counter maximum value 74, which is a storage unit that holds a maximum count value of the operation cycle counter in the next operation cycle. The remaining constituent elements shall be described later.

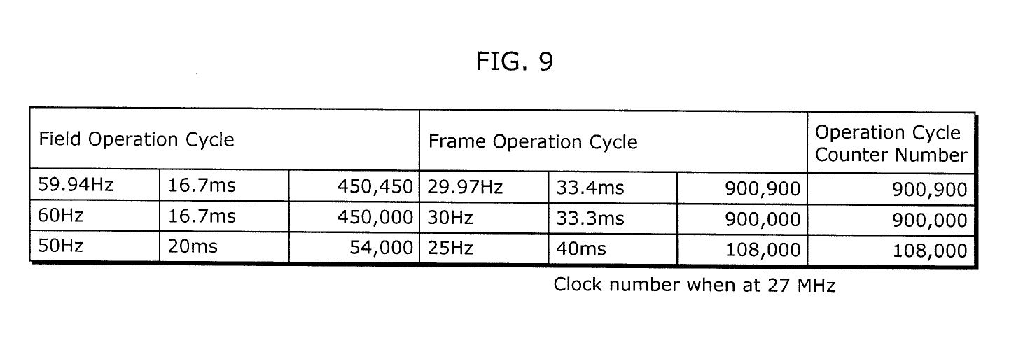

Further detailed descriptions shall be given using an example in which the field operation cycle is 59.94 Hz, 60 Hz, and 50 Hz, with reference to FIG. 9. The field operation cycle is half as long as the frame operation cycle. The operation cycle counter number of this frame operation cycle is used by the operation cycle counter 72. Assuming the operation cycle counter operates using a 27 MHz clock, it can be seen in FIG. 9 that the operation cycle counter number is set at 900,900 when the field operation cycle is 59.94 Hz. Hereafter, in the same manner, the operation cycle counter number is set at 900,000 when the field operation cycle is 60 Hz, and is set at 108,000 when the field operation cycle is 50 Hz. A value of 1 less than the operation cycle counter number is set as the operation cycle counter maximum value 74. Through this, the operation cycle counter 72 counts from 0 to 1 less than the operation cycle counter number, and the period in which that count is being carried out is the frame operation cycle.

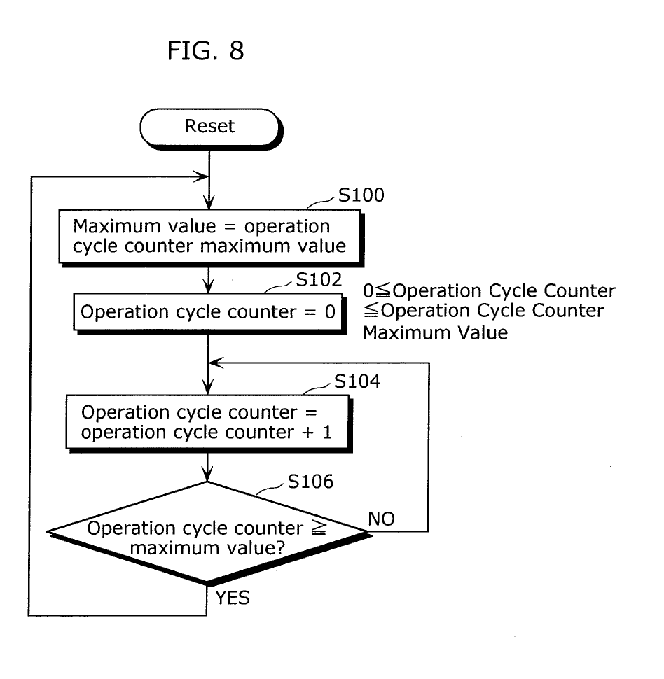

FIG. 8 is a flowchart showing an operation of the operation cycle counter. First, when the counter begins operating after being reset, the operation cycle counter maximum value 74 is loaded as the maximum value of the counter (S100). Next, the operation cycle counter 72 is reset to 0 (S102). After this, the operation cycle counter 72 counts up to 1 (S104). The process proceeds to S104 in the case where the operation cycle counter 72 is at a value less than the loaded maximum value; the process returns to S100 is the case where the operation cycle counter 72 is at a value greater than or equal to the loaded maximum value (S106).

When changing to the next operation cycle, the next operation cycle is set in the operation cycle counter maximum value 74 in the period where the count-up by the operation cycle counter 72 (S104) and the comparison of the loaded maximum value (S106) are being repeated. When the value in the operation cycle counter 72 reaches the loaded maximum value, the value set in the operation cycle counter maximum value 74 is loaded as the maximum value of the next counter (S100), and thus it is possible to change to the next operation cycle.

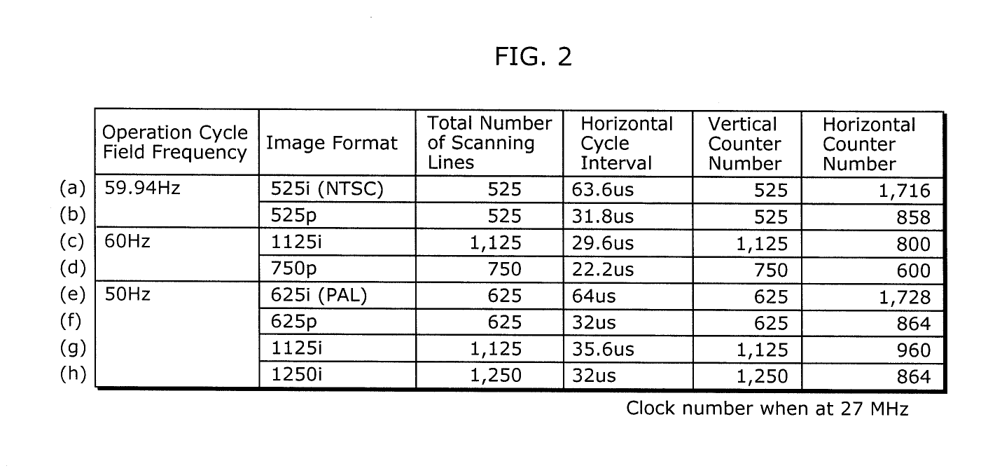

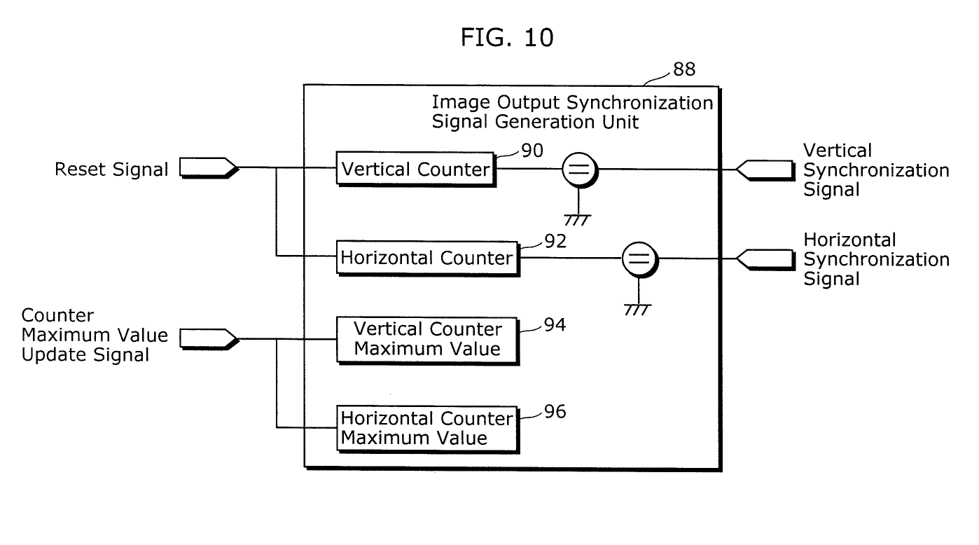

Next, descriptions shall be given regarding the configurations of the image input synchronization signal generation circuit 30, the TV image output synchronization signal generation circuit 46, and the LCD image output synchronization signal generation circuit 52. The configurations of these circuits are basically identical, and thus shall be described collectively as an image output synchronization signal generation circuit; FIGS. 10, 11, and 2 shall be used in the descriptions.

An image output synchronization signal generation circuit 88 includes: a horizontal counter 92, which is a counter synchronized with a clock and which performs counting; a vertical counter 90 that performs a count each time the horizontal counter is reset; and a vertical counter maximum value 94 and horizontal counter maximum value 96, which are storage units that hold a maximum count value for the next cycle of these counters. When the counter value of the vertical counter 90 becomes 0, a vertical synchronous signal becomes valid; when the counter value of the horizontal counter 92 becomes 0, a horizontal synchronous signal becomes valid. The image input synchronization signal generation circuit 28, TV image output synchronization signal generation circuit 48, and LCD image output synchronization signal generation circuit 54 are controlled by the vertical synchronous signal and horizontal synchronous signal.

The vertical counter maximum value and horizontal counter maximum value differ depending on the size of the image input and the image format of the image output, and the vertical counter maximum value and horizontal counter maximum value of the image input differ depending on the CCD 14 that is used.

FIG. 2 is a chart showing the total number of scanning lines, horizontal cycle period, vertical counter number, and horizontal counter number according to each operation cycle and image format. The clock is assumed as operating at 27 MHz. A value of 1 less than the horizontal counter number is set in the horizontal counter maximum value 96. Through this, the horizontal counter 92 counts from 0 to 1 less than the horizontal counter number; the period in which that count is being performed is the horizontal cycle period. A value of 1 less than the vertical count number is set in the vertical counter maximum value 94. Through this, the vertical counter 90 counts from 0 to 1 less than the vertical counter number; the period in which that count is being performed is the total number of scanning lines x the horizontal cycle period.

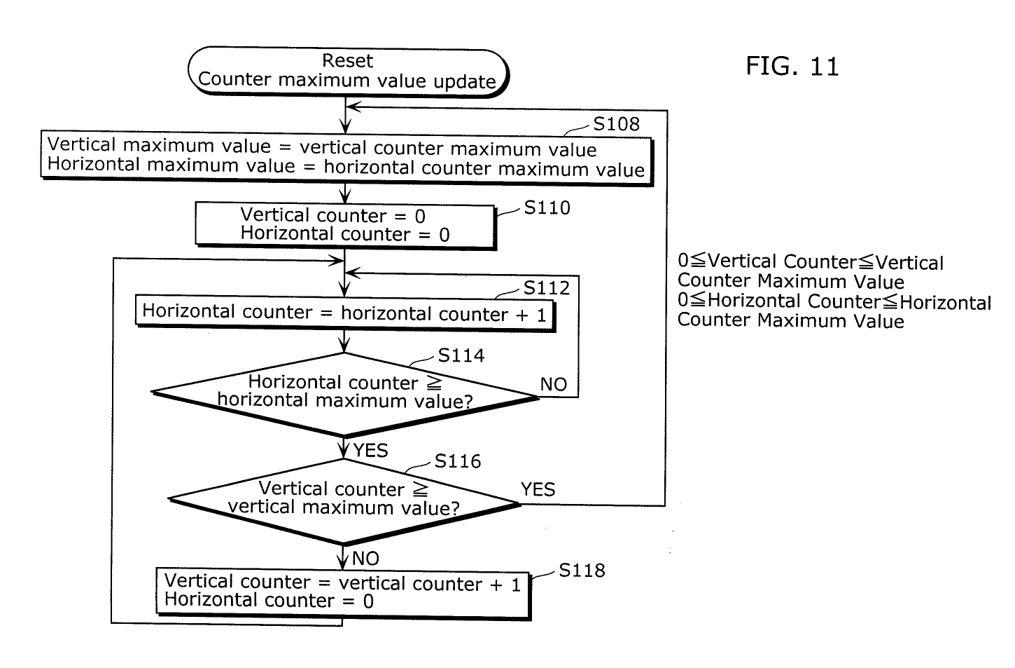

FIG. 11 is a flowchart showing an operation of these counters. First, the counters begin operating through being reset and having the counter maximum value changed. The vertical counter maximum value 94 and horizontal counter maximum value 96 are loaded as the respective maximum values of the vertical counter and horizontal counter (S108). Next, the vertical counter 90 and horizontal counter 92 are reset to 0 (S110). Then, the horizontal counter counts up to 1 (S112). The process returns to S112 in the case where the horizontal counter 92 is at a value less than the loaded horizontal counter maximum value 96; the process proceeds to S116 is the case where the horizontal counter 92 is at a value greater than or equal to the loaded horizontal counter maximum value 96 (S114).

The process proceeds to S118 in the case where the vertical counter 90 is at a value less than the loaded vertical counter maximum value 94; the vertical counter 90 counts up by 1, and the horizontal counter 92 is reset to 0 (S118). The process returns to S108 in the case where the vertical counter 90 is at a value greater than or equal to the loaded vertical counter maximum value 94 (S116), and the vertical counter maximum value 94 and horizontal counter maximum value 96 are loaded as the vertical maximum value and horizontal maximum value respectively (S108). When the horizontal counter 92 reaches the horizontal counter maximum value 96 after counting up from 0, the vertical counter 90 counts up to 1, and the horizontal counter 92 returns to 0 and once again begins to count up from 0 to the horizontal counter maximum value 96. This operation is repeated until the vertical counter 90 reaches the vertical counter maximum value 94.

When changing to the next image format, before the vertical counter maximum value 94 and horizontal counter maximum value 96 are loaded as the respective maximum values of the vertical counter and horizontal counter (S108), the values to be set for the next image format are set in the vertical counter maximum value 94 and the horizontal counter maximum value 96. When the maximum values set in the vertical counter 90 and horizontal counter 92 are reached, the values set in the vertical counter maximum value 94 and horizontal counter maximum value 96 are loaded as the maximum values of the next counter (S108), and therefore it is possible to change to the next image format.

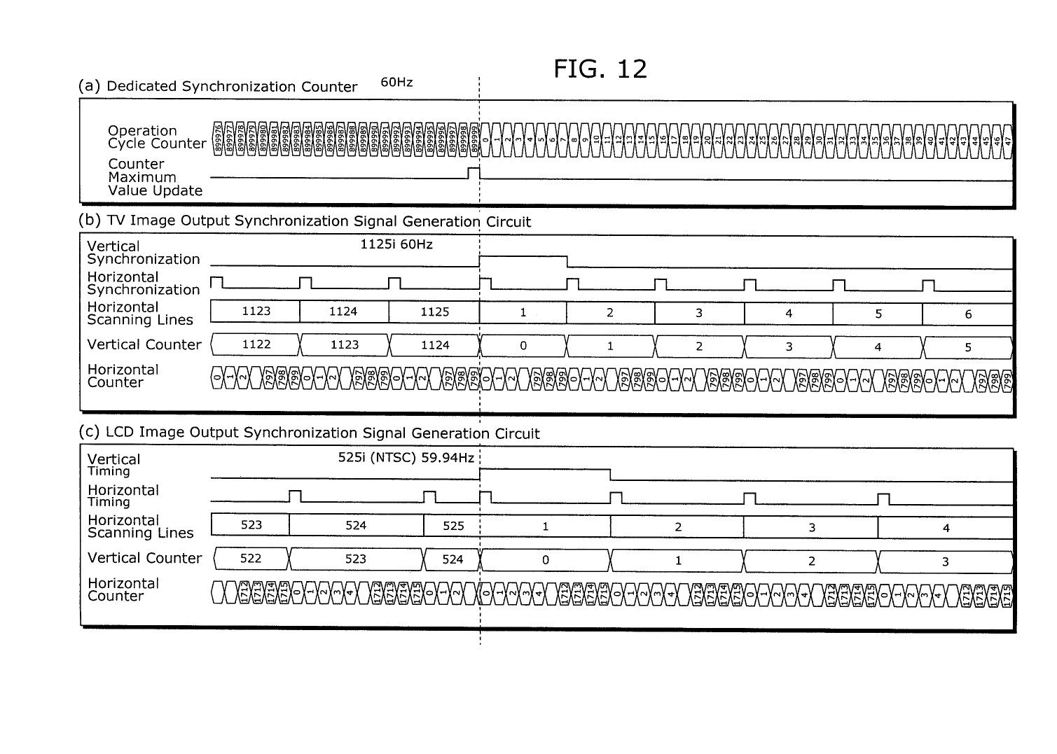

Next, further descriptions of operations synchronized by image format as performed by the dedicated synchronization counter 40, TV image output synchronization signal generation circuit 46, and LCD image output synchronization signal generation circuit 52 shown in FIG. 6 shall be given with reference to FIG. 12. Note that the operation cycle of the overall system is assumed to be 60 Hz, the TV image output is 60 Hz at 1125i, and the LCD image output is 59.94 Hz at 525i (NTSC). Furthermore, the phase adjustment of the TV image output and the phase adjustment of the LCD image output are both 0, or in other words, the reset timing of the dedicated synchronization counter 40 and the reset timings of each image output synchronization signal generation circuit are identical.

As shown in FIG. 12 (a), the operation cycle counter number of the field operation cycle (60 Hz) is 900,000 (see FIG. 9) for the dedicated synchronization counter 40, and therefore 899,999, or 1 less than the operation cycle counter number, is loaded as the counter maximum value.

Then, when the counter value reaches the loaded maximum value (899,999), a signal that controls updating of the maximum value of the counter is outputted from the dedicated synchronization counter 40 to the TV image output synchronization signal generation circuit 46 and the LCD image output synchronization signal generation circuit 52. At the same time, the dedicated synchronization counter 40 itself is loaded with 899,999, or 1 less than the operation cycle counter number, as the operation cycle counter maximum value; in the next block, the operation cycle counter is reset to 0, the operation cycle counter counts up to 899,999, and this process is repeated.

As shown in FIG. 12 (b), the TV image output synchronization signal generation circuit 46 is 1125i at 60 Hz, and therefore the vertical counter number is 1125 (see FIG. 2), and 1124, or 1 less than the vertical counter number, is set as the vertical counter maximum value. In addition, the horizontal counter number is 800, and therefore 799, or 1 less than the horizontal counter number, is set as the horizontal counter maximum value. After the horizontal counter reaches 799 from 0 and the next block starts, the vertical counter counts up to 1. The horizontal counter and vertical counter continue to count up until the vertical counter reaches 1124 and the horizontal counter reaches 799. When the vertical counter reaches 1124 and the horizontal counter reaches 799, the dedicated synchronization counter 40 outputs a signal for updating the maximum value of the counters of the TV image output synchronization signal generation circuit 46; accordingly, 1124, or 1 less than the vertical counter number, is loaded as the vertical counter maximum value, while 799, or 1 less than the horizontal counter number, is loaded as the horizontal counter maximum value. In the next block, the vertical counter and horizontal counter are reset to 0, and the count-up is repeated once again.

As shown in FIG. 12 (c), the LCD image output synchronization signal generation circuit 52 is 525i at 59.94 Hz, and therefore the vertical counter number is 525 (see FIG. 2), and 524, or 1 less than the vertical counter number, is set as the vertical counter maximum value. In addition, the horizontal counter number is 1716, and therefore 1715, or 1 less than the horizontal counter number, is set as the horizontal counter maximum value. After the horizontal counter reaches 1715 from 0 and the next block starts, the vertical counter counts up to 1. The vertical counter repeats the count-up until it reaches 524. When the vertical counter reaches 524 and the horizontal counter is between 0 and 1715 (the count value of the horizontal counter is 815), the dedicated synchronization counter 40 outputs a signal for updating the maximum value of the counters of the LCD image output synchronization signal generation circuit 52; accordingly, 524, or 1 less than the vertical counter number, is loaded as the vertical counter maximum value, while 1715, or 1 less than the horizontal counter number, is loaded as the horizontal counter maximum value. In the next block, the vertical counter and horizontal counter are reset to 0, and the count-up is repeated once again. Operating in such a manner means that the entirety of one frame cannot be displayed in the LCD; however, this is within a range not easily detected by the human eye, and therefore the LCD image is synchronized to the TV image.

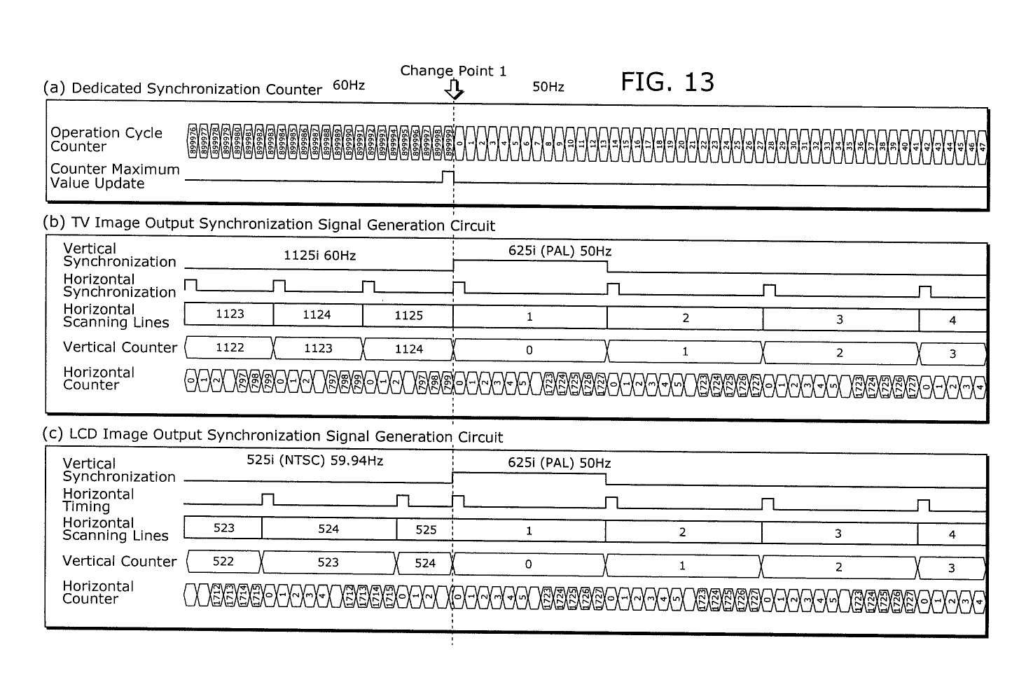

Further detailed descriptions of operations in the case of switching the image format of the TV image output synchronization signal generation circuit 46 and the LCD image output synchronization signal generation circuit 52 using the dedicated synchronization counter 40 shall be given with reference to FIG. 13.

At change point 1, the operation cycle of the overall system changes from 60 Hz to 50 Hz, the TV image output synchronization signal generation circuit 46 changes from 1125i at 60 Hz to 625i (PAL) at 50 Hz, and the LCD image output synchronization signal generation circuit 52 changes from 525i (NTSC) at 59.94 Hz to 625i (PAL) at 50 Hz. Furthermore, the phase adjustment of the TV image output and the phase adjustment of the LCD image output are both 0, or in other words, the reset timing of the dedicated synchronization counter 40 and the reset timings of each image output synchronization signal generation circuit are identical.

As shown in FIG. 13 (a), the dedicated synchronization counter 40 has a field operation cycle of 60 Hz with an operation cycle counter number of 900,000, and a field operation cycle of 50 Hz with an operation cycle counter number of 108,000 (see FIG. 9). When the operation cycle counter reaches the loaded maximum value of 899,999, a signal for controlling the update of the counter maximum value is outputted from the dedicated synchronization counter 40 to the TV image output synchronization signal generation circuit 46 and the LCD image output synchronization signal generation circuit 52. At the same time, the dedicated synchronization counter 40 itself is loaded with 107,999, or 1 less than the operation cycle counter number, as the operation cycle counter maximum value; in the next block, the operation cycle counter is reset to 0, the operation cycle counter counts up to 107,999, and this process is repeated.

As shown in FIG. 13 (b), the TV image output synchronization signal generation circuit 46 changes from 1125i at 60 Hz to 625i (PAL) at 50 Hz. Accordingly, the vertical counter number changes from 1125 to 625, and the horizontal counter number changes from 800 to 1728 (see FIG. 2, (c) and (e)). When the maximum value of the TV image output counter is updated, 624, or 1 less than the vertical counter number, is loaded as the vertical counter maximum value, and 1727, or 1 less than the horizontal counter number, is loaded as the horizontal counter maximum value. In the next block, the vertical counter and horizontal counter are reset to 0, and the count-up is repeated once again.

As shown in FIG. 13 (c), the LCD image output synchronization signal generation circuit 52 changes from 525i at 59.94 Hz to 625i (PAL) at 50 Hz. Accordingly, the vertical counter number changes from 525 to 625, and the horizontal counter number changes from 1716 to 1728 (see FIG. 2, (a) and (e)). When the vertical counter is 524 and the horizontal counter is 815, a signal for updating the maximum value is outputted from the dedicated synchronization counter 40. Through this, the maximum value of the LCD image output counter is updated, 624, or 1 less than the vertical counter number, is loaded as the vertical counter maximum value, and 1727, or 1 less than the horizontal counter number, is loaded as the horizontal counter maximum value. In the next block, the vertical counter and horizontal counter are reset to 0, and the count-up is repeated once again. In this manner, by using the dedicated synchronization counter 40 as a standard, the TV image output synchronization signal generation circuit 46 and the LCD image output synchronization signal generation circuit 52 can be synchronized easily, and it is possible to change the operation frequency and image format of the video (TV) and liquid-crystal display (LCD) image output circuits without taking into consideration the current image format of those image output circuits.

While descriptions have thus far been omitted, it should be noted here that the image input synchronization signal generation circuit 30 can also be synchronized using the dedicated synchronization counter 40, through the same setup as with the TV image output synchronization signal generation circuit 46 and the LCD image output synchronization signal generation circuit 52.

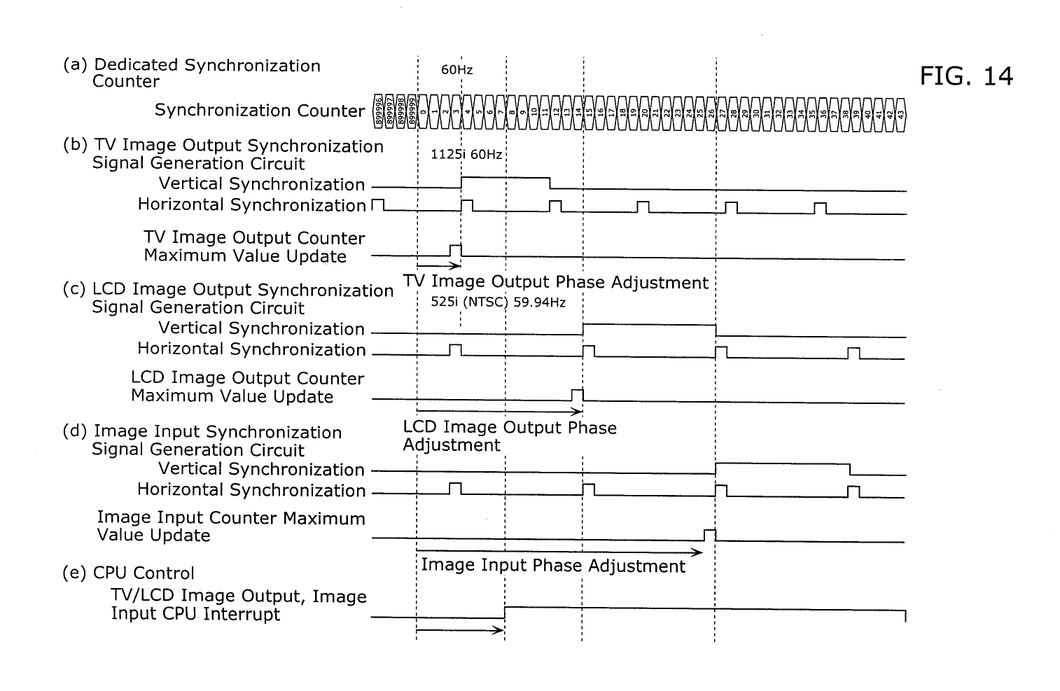

Next, explanations shall be given regarding phase adjustment of the TV image output synchronization signal generation circuit 46, LCD image output synchronization signal generation circuit 52, and image input synchronization signal generation circuit 30 using the dedicated synchronization counter 40, with reference to FIGS. 7 and 14. FIG. 14 is a timing chart showing timings in the case of performing phase adjustment. These phase adjustments are performed by overwriting a TV image output phase adjustment value 76, an LCD image output phase adjustment value 80, and an image input phase adjustment value 84.

When the operation cycle counter 72 shown in FIG. 7 and the TV image output phase adjustment value 76 match, the maximum value of the TV image output counter is updated. Similarly, when the operation cycle counter 72 and the LCD image output phase adjustment value 80 match, the maximum value of the LCD image output counter is updated. When the operation cycle counter 72 and the image input phase adjustment value 84 match, the maximum value of the image input counter is updated.

Conventionally, phase adjustment is performed using a vertical counter and horizontal counter of an image output unit as the standard; however, with such a method, it is necessary to re-set the amount of phase adjustment in accordance with the image format when changing the image format of the vertical counter and horizontal counter, which are used as the standard. Therefore, the present invention simplifies the setting procedure by performing phase adjustment with the dedicated synchronization counter 40 used as the standard.

Next, explanations shall be given regarding a CPU interrupt. When changing the settings of the TV image output circuit 44, LCD image output circuit 50, and image input circuit 26, control must be performed by intervals in which images are not outputted and intervals in which images are not inputted, such as vertical blanking intervals, so that the setting operations are not disturbed. CPU interrupts are therefore used to notify the CPU 38 of timings at which control can be performed without problems arising. Here, “control” specifically refers to the following: changing the vertical counter maximum values and horizontal counter maximum values in the TV image output synchronization signal generation circuit 46, LCD image output synchronization signal generation circuit 52, or the like; setting, in the TV display processing circuit 48, the LCD display processing circuit 54, and so on, an interval in which images are not to be displayed (vertical blanking intervals and horizontal blanking intervals differ depending on the image format); a setting in the TV display processing circuit 48, the LCD display processing circuit 54, and so on for superimposing information such as the screen aspect ratio; setting an on-screen display (OSD) to display data/hide data/display content (for example, displaying a channel number on the TV screen); and changing the vertical counter maximum value and horizontal counter maximum value in the image input synchronization signal generation circuit 30 (because the number of pixels processed in still-image filming, moving image filming, and monitor modes differ).

When the operation cycle counter 72 in FIG. 7 and a TV image output control timing 78 match, a TV image output CPU interrupt occurs. The CPU 38 uses this CPU interrupt to control the TV image output circuit 44. Similarly, when the operation cycle counter 72 and a liquid-crystal display (LCD) image output control timing 82 match, a liquid-crystal display (LCD) image output CPU interrupt occurs. The CPU 38 uses this CPU interrupt to control the liquid-crystal display (LCD) image output circuit 50. When the operation cycle counter 72 and an image input control timing 86 match, an image input CPU interrupt occurs. The CPU 38 uses this CPU interrupt to control the image input circuit 26.

As shown in FIG. 14 (b), in the TV image output synchronization signal generation circuit 46, the output position of the TV image output counter maximum value update (resetting and updating the counter maximum value) is changed using the TV image output phase adjustment value 76, and thus it is possible for the dedicated synchronization counter 40 adjust the phase of the TV image output synchronization signal generation circuit 46.

As shown in FIG. 14 (c), in the LCD image output synchronization signal generation circuit 52, the output position of the LCD image output counter maximum value update (resetting and updating the counter maximum value) is changed using the LCD image output phase adjustment value 80, and thus it is possible for the dedicated synchronization counter 40 adjust the phase of the LCD image output synchronization signal generation circuit 52.

As shown in FIG. 14 (d), in the image input synchronization signal generation circuit 30, the output position of the image input counter maximum value update (resetting and updating the counter maximum value) is changed using the image input phase adjustment value 84, and thus it is possible for the dedicated synchronization counter 40 adjust the phase of the image input synchronization signal generation circuit 30.

As shown in FIG. 14 (e), the output position of the TV image output CPU interrupt, LCD image output CPU interrupt, and image input CPU interrupt are changed using the TV image output control timing 78, LCD image output control timing 82, and image input control timing 86, and thus it is possible for the dedicated synchronization counter 40 to phase-adjust the output position of the TV image output synchronization signal generation circuit 46, LCD image output synchronization signal generation circuit 52, and image input synchronization signal generation circuit 30.

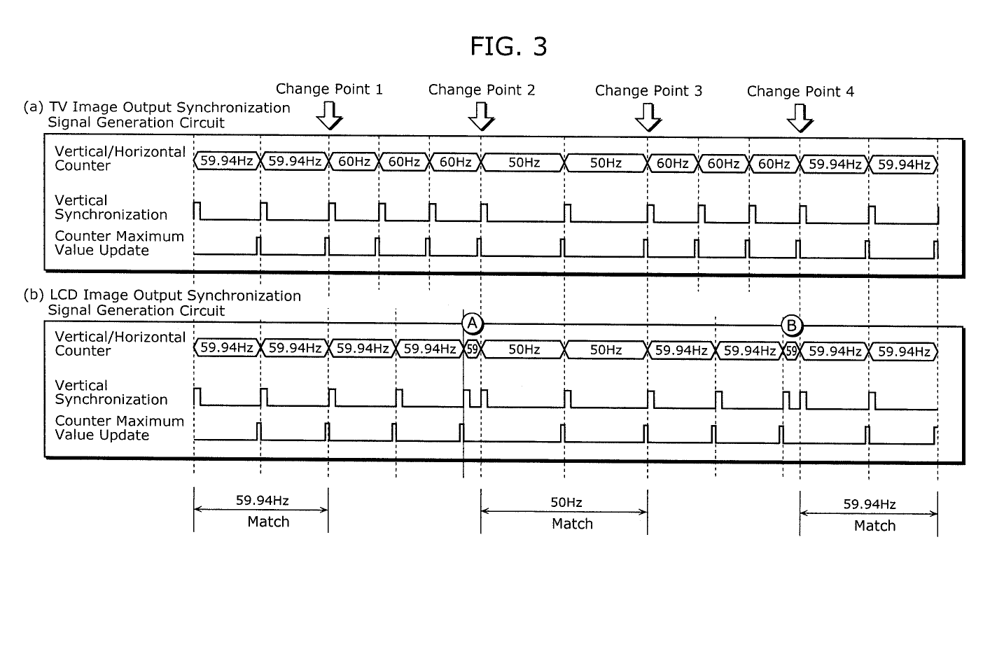

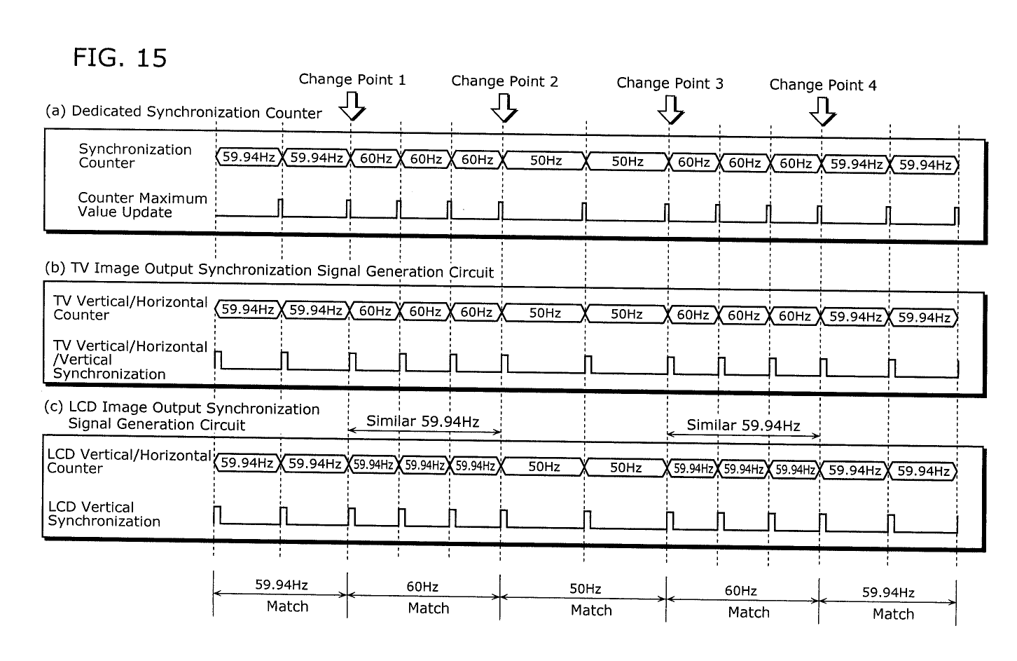

Using the dedicated synchronization counter 40 of the present invention to unify the operation cycle of the overall system results in operations as shown in FIG. 15, and the problem that arises when simply splitting the image output synchronization signal generation circuit 62 in two, as shown in FIG. 3, can be avoided thereby.

In the case of changing the dedicated synchronization counter 40 and TV image output from 59.94 Hz to 60 Hz, as occurs at change point 1, the TV image output, at 60 Hz, and the LCD image output, at 59.94 Hz, have differing operation cycles and thus a mismatch occurs; however, a reset and a counter maximum value update are outputted from the dedicated synchronization counter 40 in the 60 Hz operation cycle, and a reset and a counter maximum value update are outputted from the dedicated synchronization counter 40 during the 59.94 Hz operation cycle of the LCD image output, and therefore the LCD image output is synchronized to the TV image output which is operating at 60 Hz.

In the case of changing the dedicated synchronization counter 40 and TV image output from 60 Hz to 50 Hz, as occurs at change point 2, a reset and counter maximum value update are outputted at a 50 Hz operation cycle from the dedicated synchronization counter 40 to the TV image output and the LCD image output, and therefore the operation cycle can be changed while maintaining the synchronization of the outputs.

Also, in the case of changing the dedicated synchronization counter 40 and TV image output from 50 Hz to 60 Hz, and the LCD image output from 50 Hz to 59.94 Hz, as occurs at change point 3, the TV image output, at 60 Hz, and the LCD image output, at 59.94 Hz, have differing operation cycles and thus a mismatch occurs; however, a reset and a counter maximum value update are outputted from the dedicated synchronization counter 40 in the 60 Hz operation cycle, and a reset and a counter maximum value update are outputted from the dedicated synchronization counter 40 during the 59.94 Hz operation cycle of the LCD image output, and therefore the LCD image output is synchronized to the TV image output which is operating at 60 Hz.

Furthermore, in the case of changing the dedicated synchronization counter 40 and TV image output from 60 Hz to 59.94 Hz, as occurs at change point 4, a reset and counter maximum value update are outputted at a 59.94 Hz operation cycle from the dedicated synchronization counter 40 to the TV image output and the LCD image output, and therefore the operation cycle can be changed while maintaining the synchronization of the outputs.

As has been described thus far, according to the present invention, the image output synchronization signal generation circuits for TV and LCD image output can easily be synchronized by using the dedicated synchronization counter 40 as a standard, and it is possible to change the operation cycles and image formats of video (TV) and liquid-crystal display (LCD) image output circuits without taking the current image format of those image output circuits into consideration.

Furthermore, when performing phase adjustment on the output starting position of the LCD image output signal and the TV image output signal, the dedicated synchronization counter 40, which is used as the standard, does not include the horizontal counter and vertical counter concepts, and therefore phase adjustment through absolute delay becomes possible.

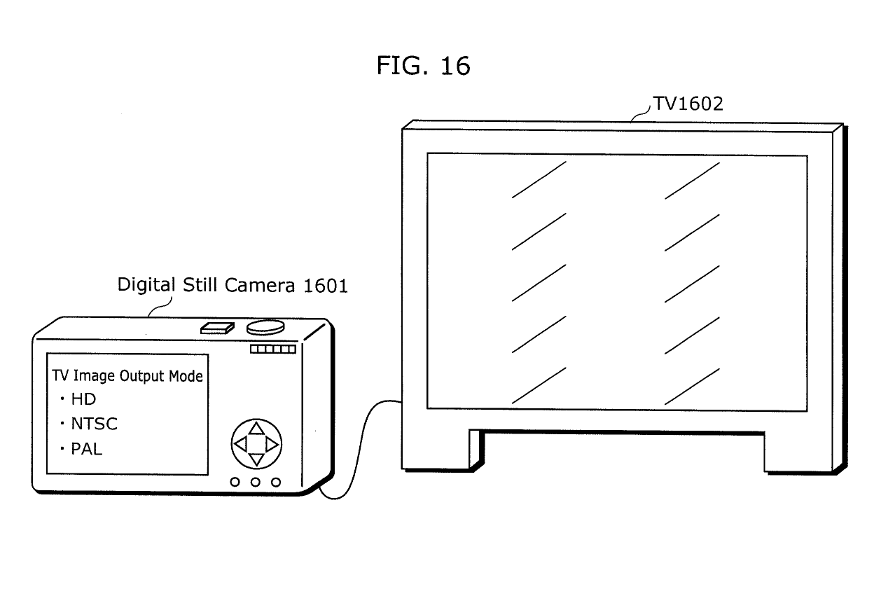

Note here that FIG. 16 is a diagram showing an example where a digital still camera 1601 that includes the image output apparatus of the present invention is connected to a TV 1602 and the image output format is changed. As shown in this diagram, the digital still camera 1601 and the TV 1602, which is HD-compliant, are connected via a cable, and by selecting and changing the types of image output signals, such as HD, NTSC, PAL, and so on sent from the digital still camera 1601, it is possible to output an image signal, from the digital still camera 1601 to the TV 1602, which corresponds to the operation cycle and image format of the image signal in the TV 1602.

Descriptions of an image output apparatus and digital camera according to the present invention have been given thus far with reference to the drawings, but the present invention is not limited to the image output apparatus and digital camera shown in the drawings.

Furthermore, the dedicated synchronization counter 40, which is a synchronization unit that synchronizes plural image signals outputted from plural image signal output units of the present invention, has been described as a single counter that does not have a vertical counter or a horizontal counter; however, the present invention is not limited to a single counter, and an embodiment in which the dedicated synchronization counter is divided in two, four, or the like can also be considered. For example, the interlace image format has even-numbered fields and odd-numbered fields, and thus the present invention can be implemented when dividing the synchronization counter into a 1-bit counter and a synchronization counter.

Although only one exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The image output apparatus according to the present invention is applicable in digital still cameras that film photographs (still images), digital video cameras that film video (moving images) and so on, and is applicable in personal computers, video game devices, cellular telephones, and so on which can output plural images.

What is claimed is:

1. An image output apparatus which outputs an image signal to plural display devices, said apparatus comprising:
plural image signal output units, each of which is operable to output an image signal corresponding to at least one image format; and
a synchronization unit operable to synchronize the plural image signals outputted from said plural image signal output units.

2. The image output apparatus according to claim 1,
wherein said synchronization unit includes a synchronization counter which can count to a maximum value set in accordance with the cycle of an image format, and
said synchronization unit is operable to synchronize the plural image signals based on the count value of the synchronization counter.

3. The image output apparatus according to claim 2,
wherein each of said plural image signal output units includes an image output synchronization signal generation unit having a vertical counter and a horizontal counter, both of which can count to the set maximum value, and
said synchronization unit is operable to synchronize the count value of said synchronization counter with the vertical counter and horizontal counter included in said plural image output synchronization signal generation units.

4. The image output apparatus according to claim 3,
wherein said synchronization unit is operable to adjust the phase of the outputted image signal when the count value of said synchronization counter is a predetermined value so that the vertical counter and horizontal counter are reset.

5. The image output apparatus according to claim 3, further comprising
a CPU which can perform a predetermined processing in accordance with a CPU interrupt,
wherein said CPU signals a CPU interrupt when said synchronization counter reaches a predetermined value, and
said synchronization unit is operable to set the vertical counter and horizontal counter due to the CPU interrupt.

6. The image output apparatus according to claim 3, further comprising
an image signal input unit which is inputted with an image signal and which includes an image input synchronization signal generation unit having an input signal vertical counter and an input signal horizontal counter, both of which can count to the set maximum value,
wherein said synchronization unit is operable to synchronize the synchronization counter, the vertical counters and horizontal counters included in the plural image output synchronization signal generation unit, and the input signal vertical counter and input signal horizontal counter included in the image input synchronization signal generation unit.

7. The image output apparatus according to claim 6,
wherein said synchronization unit is operable to adjust the phase of the inputted image signal when the count value of said synchronization counter is a predetermined value so that the input signal vertical counter and input signal horizontal counter are reset.

8. The image output apparatus according to claim 3, further comprising
a CPU which can perform a predetermined processing in accordance with a CPU interrupt,
wherein said CPU signals a CPU interrupt when said synchronization counter reaches a predetermined value, and
said synchronization unit is operable to set the input signal vertical counter and input signal horizontal counter due to the CPU interrupt.

9. An imaging apparatus comprising the image output apparatus according to claim 1.

10. An image output method for use in an image output apparatus that can output an image signal to plural display devices,
wherein the image output apparatus outputs an image signal to plural display devices, and includes:
plural image signal output units, each of which outputs an image signal corresponding to at least one image format; and
a synchronization unit which synchronizes the plural image signals outputted from said plural image signal output units, and
said method comprises:
outputting, via each image signal output unit, the image signal corresponding to at least one image format; and
synchronizing the plural image signals outputted from said plural image signal output units.

11. The image output method according to claim 10,
wherein in said synchronizing, the plural image signals are synchronized based on the count value of a synchronization counter which can count to a maximum value set in accordance with the cycle of an image format.

12. The image output method according to claim 11,
wherein in each instance of said outputting, an image output synchronization signal generation unit, in which a vertical counter and a horizontal counter can count to a set maximum value, is used, and
in said synchronizing, the count value of the synchronization counter is synchronized with the vertical counter and horizontal counter included in the image output synchronization signal generation unit.

13. A program for use in an image output apparatus that can output an image signal to plural display devices,
wherein the image output apparatus outputs an image signal to plural display devices, and includes:
plural image signal output units, each of which outputs an image signal corresponding to at least one image format; and
a synchronization unit which synchronizes the plural image signals outputted from said plural image signal output units, and
said program comprises:
outputting, via each image signal output unit, the image signal corresponding to at least one image format; and
synchronizing the plural image signals outputted from said plural image signal output units.

14. The program according to claim 13,
wherein in said synchronizing, the plural image signals are synchronized based on the count value of a synchronization counter which can count to a maximum value set in accordance with the cycle of an image format.

15. The program according to claim 14,
wherein in each instance of said outputting, an image output synchronization signal generation unit, in which a vertical counter and a horizontal counter can count to a set maximum value, is used, and
in said synchronizing, the count value of the synchronization counter is synchronized with the vertical counter and horizontal counter included in the image output synchronization signal generation unit.
